(19) United States
(12) Patent Application Publication
(10) Pub. No.: US 2021/0347227 A1
(43) Pub. Date: Nov. 11, 2021

(54) AIR VENT FOR VEHICLES AND METHOD FOR PRODUCING SUCH AN AIR VENT

(71) Applicant: ILLINOIS TOOL WORKS INC., Glenview, IL (US)

(72) Inventor: Günther KRÄMER, Enkenbach-Alsenborn (DE)

(21) Appl. No.: 17/315,499

(22) Filed: May 10, 2021

(30) Foreign Application Priority Data
May 11, 2020 (DE) 10 2020 112 682.4

(51) Int. Cl. B60H 1/24

(52) U.S. Cl. CPC B60H 1/24

(57) ABSTRACT

An air vent (1) for vehicles, including a housing (6) and a kinematic assembly (2) which can be accommodated at least partly by the housing (6) and includes two side plates (3) and at least one air-guiding element (4) which is movable between the two side plates (3) relative to the side plates (3), wherein the kinematics (5) required for coordinating movement of the at least one air-guiding element (4) are integrated into the side plates (3) or provided on the side plates (3), and wherein the side plates (3) have a shape that is independent of the kinematics (5) required for coordinating the movement of the at least one air-guiding element (4) and is at least regionally complementary to an adapter region (8) of the housing (6), such that, in order to form a kinematics module (7), the housing (6) is releasably connectable to differently configured kinematic assemblies.

### TECHNICAL FIELD

The present invention relates generally to air vent systems for supplying air into a vehicle interior of a vehicle, and in particular to corresponding air vents.

### BACKGROUND

The air vents typically used in ventilation devices for vehicles are air vents that enable the exiting or outflowing air stream to be controlled in a targeted manner. Such air vents are used to supply in particular fresh air into a vehicle interior.

The air stream flows through an inlet opening of the respective air vent into an air duct which is at least partly delimited by the housing wall of the air vent, through said air duct, and ultimately through the outlet opening of the air vent into the interior of the vehicle (for example a car or truck). The flow strength, i.e. the amount of air flowing into the interior of the vehicle via the air vent per unit of time, can usually be adjusted, in particular manually, via a controlling element.

Air vents are usually also equipped with air flow directing or air flow regulating air-guiding elements, which can be accordingly manipulated to achieve a targeted deflection or directing of the air flow emitted by the air vent. This directing can be in a horizontal and/or vertical direction, for example, and is likewise manually adjustable by means of controlling elements.

The air vents usually also comprise closing means to move them manually from an open state, in which air can flow out of the air vent, to a closed state, in which no air can flow out of the air vent, and vice versa.

It is furthermore usually also possible to adjust the temperature of individual air vents, or a plurality of air vents together, in order to supply cooled or heated air into the vehicle interior.

In summary therefore, for air vents it is usually possible to adjust an open/closed state, a flow temperature, a flow strength and a flow direction by means of controlling elements. The controlling elements are often individually adjustable by hand and then usually remain in their set position.

However, air vents known from the state of the art are usually structured such that they are configured for a specific purpose, for example for a specific vehicle type or for a special arrangement in the vehicle interior. Air vents inside a vehicle, for example along a vehicle dashboard, can also have different configurations, whereby the air vents differ in terms of the shape and configuration of the housing, the number of air-guiding elements and the configuration of closing means and panels disposed on the front or on either side.

It has therefore been customary to design a separate air vent for each individual vehicle type and also for each position. This results in relatively high production costs, since the air vents can often only be produced in small quantities and a separate air vents has to be designed and produced for each application.

The resulting additional effort incurs considerable expense and is relatively time-consuming. It is furthermore necessary to check the vent performance of every air vent.

### SUMMARY

Based on this problem, the underlying object of the present invention is therefore to further develop an air vent of the aforementioned type such that a universal applicability of the air vent is ensured.

With respect to the air vent, the underlying object of the invention is solved by the subject matter of independent claim 1, whereby advantageous further developments of the air vent according to the invention are specified in the dependent claims 2 to 17.

The invention accordingly relates in particular to an air vent for vehicles comprising a housing and a kinematic assembly, which can be accommodated at least partly by the housing. The kinematic assembly provides the kinematics necessary for manipulating the individual air-guiding elements of the air vent.

The kinematic assembly in particular comprises two side plates and at least one air-guiding element that can be moved and in particular pivoted between the two side plates relative to the side plates, whereby said at least one air-guiding element is accordingly mounted by the two side plates of the kinematic assembly.

According to the invention, it is in particular provided in this context that the kinematics required for coordinating the movement of the at least one air-guiding element are preferably completely integrated into the side plates or provided on the side plates.

With respect to the side plates of the kinematic assembly according to the invention, it is in particular provided that said side plates have a shape that is in particular preferably independent of the kinematics required for coordinating the movement of the at least one air-guiding element, whereby the shape of the two side plates of the kinematic assembly is in particular configured such that it is at least regionally complementary to an adapter region of the housing of the air vent, so that the housing can be connected to differently configured kinematic assemblies to form a kinematics module.

In this context, it is in particular provided that the housing is connectable to different kinematic assemblies, whereby the kinematic assemblies differ in particular in the number of air-guiding elements and/or in the kinematics needed for coordinating the movement of the at least one air-guiding element relative to the side plates.

The advantages that can be achieved with the solution according to the invention are obvious: according to the invention, it is in particular provided that the kinematics required for manipulating the at least one air-guiding element of the air vent are integrated into the side plates of the kinematic assembly or are provided on the side plates of the kinematic assembly. Moving the kinematics required for manipulating the at least one air-guiding element into the side plates of the kinematic assembly makes it possible to achieve a simplified and in particular modular structure of the air vent, because one and the same housing can be used for the air vent, regardless of the specific purpose of the air vent. Therefore only the kinematics configured in or integrated into the side plates of the kinematic assembly have to be modified depending on the specific purpose of the air vent.

In other words, the invention enables the construction and the configuration/design of the air vent in accordance with a type of “building block system.” While most of the components of the air vent, such as the housing of the air vent, remain structurally unchanged, different air vents and in particular air vents for different purposes can easily be created; namely by simply adapting the kinematics integrated into the side plates of the kinematic assembly or the kinematics provided on the side plates of the kinematic assembly to suit the specific purpose of the air vent.

On the other hand, according to further developments of the solution according to the invention, it is provided that different kinematics can be implemented in the side plates of the kinematic assembly or on the side plates of the kinematic assembly, so that, when creating a special air vent in accordance with the building block principle, appropriate modularly constructed side plate arrangements with suitable kinematics can be used.

Thus, according to one implementation of the air vent according to the invention, it is provided that the kinematic assembly comprises a plurality of air-guiding elements, which are respectively mounted between the two side plates of the kinematic assembly such that they are movable and in particular pivotable relative to the side plates.

In this context, it is in particular useful for a coupling mechanism to be integrated into the side plates of the kinematic assembly, or disposed on the side plates of the kinematic assembly, for coordinating the movements of the plurality of air-guiding elements relative to one another and relative to the two side plates of the kinematic assembly.

Alternatively or additionally, it is conceivable for at least one slotted guide to be configured in the side plates of the kinematic assembly, in which a driver connected to the at least one air-guiding element of the kinematic assembly is or can be accommodated to define and/or guide a movement of the at least one air-guiding element relative to the two side plates of the kinematic assembly.

Of course, in this context, other embodiments for suitable kinematics to manipulate the at least one air-guiding element of the kinematic assembly are possible as well, whereby said kinematics can be integrated into the side plates of the kinematic assembly or can at least be disposed on the two side plates of the kinematic assembly.

It is thus clear that the solution according to the invention is in particular characterized in that preferably all of the parameters/properties characterizing the function of the air vent and the associated kinematics are moved into the side plates of the kinematic assembly, so that, to create a specific air vent, it is necessary only to select a side plate pair comprising suitable kinematics, preferably from a large number of previously defined or definable side plates comprising suitable kinematics, which can be integrated into the rest of the modularly configured components of the air vent.

To simplify the integration of the kinematic assembly, it is provided according to a further development of the air vent according to the invention that the adapter region of the housing of the air vent, or the adapter region of the housing of the kinematics module ultimately formed with the kinematic assembly of the air vent, is at least partly configured as a snap-fitting or latching mechanism in order to create a preferably releasable snap-fitting or latching connection with the two side plates of the kinematic assembly.

Alternatively or additionally, it is conceivable that the adapter region of the housing is at least partly configured to accommodate the side plates of the kinematic assembly at least regionally in a form-fitting manner.

These embodiments enable a simplified installation of the individual modules of the air vent, and in particular the kinematic assembly with the housing of the air vent, whereby the corresponding “kinematics module” is formed when the housing and the kinematic assembly are combined. This is a module of the air vent, which contains all of the kinematics elements necessary for manipulating the at least one air-guiding element of the air vent.

According to preferred implementations of the air vent according to the invention, it is provided that the air vent further comprises a preferably modularly constructed actuating element for, in particular manually, manipulating the at least one air-guiding element of the kinematic assembly. The modular structure of the actuating element in particular includes the functionality of the actuating element to be, preferably releasably or interchangeably, connectable to the at least one air-guiding element of the kinematic assembly.

According to preferred further developments of the air vent according to the invention, it is provided that the air vent further comprises a slat module, which can be connected, selectively or as needed and preferably releasably, to an air inlet region of the kinematics module formed by the kinematic assembly and the housing.

The slat module preferably comprises at least one and in particular a plurality of air-guiding slats or air-guiding elements oriented perpendicular to the at least one air-guiding element of the kinematic assembly to shut off or laterally deflect an air flow flowing through the air vent as needed.

In order to be able to preferably releasably connect the optionally provided slat module to the kinematics module, according to preferred implementations of this further development of the air vent according to the invention, it is provided that the slat module comprises a housing, in which the at least one and preferably the plurality of air-guiding slats/the at least one and preferably the plurality of air-guiding elements are mounted such that they are movable and in particular pivotable relative to the housing, whereby the housing can preferably be releasably connected to the air inlet region of the housing of the kinematic assembly via a snap-fitting or latching connection.

According to embodiments of the air vent according to the invention, the housing of the slat module can be integrally connected to the housing of the air vent.

In this context, it is conceivable that the housing of the slat module comprises two side plates, whereby the at least one and preferably the plurality of air-guiding slats/air-guiding elements are accommodated or mounted between the two side plates such that the at least one and preferably the plurality of air-guiding slats are movable and in particular pivotable relative to the side plates.

With a corresponding advantageous design of the side plates, it is in principle conceivable to use a housing for the modular air vent that integrally connects the rear housing (i.e. the housing of the slat module) and the kinematics module, and in particular a housing of the kinematics module. There would thus be only one housing, which then permits the creation of variants via the kinematic assembly, in particular via the variation of the side plates.

In this context, it is in particular useful for the housing of the slat module to preferably comprise a centering and/or guide element and the housing of the kinematic assembly to comprise a complementary element, in order to properly center and/or orient the housing of the slat module when it is installed on the housing of the kinematic assembly.

The slat module preferably comprises a plurality of air-guiding slats or air-guiding elements that can be moved and in particular pivoted relative to the housing of the slat module, whereby a coupling mechanism is further provided for coupling the movement of the individual air-guiding slats/air-guiding elements of the slat module.

According to a particularly preferred configuration of the air vent of the aforementioned further development, it is provided that the kinematic assembly comprises at least one and preferably two additional and in particular peripheral air-guiding elements, which can be moved and in particular pivoted relative to the at least one air-guiding element of the kinematic assembly and relative to the housing of the air vent, and which extend(s) parallel to the at least one air-guiding element of the kinematic assembly and perpendicular to the at least one air-guiding element of the slat module.

In this context, it is in particular provided that the at least one additional air-guiding element of the kinematic assembly is associated with a coupling mechanism, whereby the coupling mechanism is configured to preferably orient the at least one additional air-guiding element of the kinematic assembly with respect to the at least one air-guiding element of the kinematic assembly and in particular in the opposite direction to the at least one air-guiding element of the kinematic assembly.

This configuration makes it possible to optimally direct the air flow to be emitted by the air vent with a particularly compact design of the air vent.

With respect to the coupling mechanism, it is conceivable in this context for said coupling mechanism to comprise at least one lever arm, which is connected in an articulated manner to an end face of the at least one additional air-guiding element of the kinematic assembly on one side and in an articulated manner to an end face of the at least one air-guiding element of the kinematic assembly on the other side. However, other embodiments for a corresponding coupling mechanism are also possible here of course.

The aforementioned, optionally provided actuating element of the air vent preferably comprises a force transmission element, the end region of which is operatively connected or operatively connectable to one of the at least one air-guiding slats/to an air-guiding element of the slat module. One and the same actuating element can thus be used to manipulate not only the at least one air-guiding element of the kinematic assembly or the kinematics module, but also the at least one air-guiding slat/air-guiding element of the slat module as needed.

According to a further aspect of the present invention, it is provided that the air vent further comprises a panel arrangement, which can be connected to the kinematics module of the air vent preferably in a releasable or interchangeable manner.

In this context, it is in particular useful for the panel arrangement to comprise first panels for covering the end plates as needed, and a second panel for covering the housing of the kinematics module at the air-outlet region of the air vent at least partly as needed.

In this context, it is preferably provided that the side plates of the kinematic assembly comprise snap-fitting or latching elements to create a snap-fitting or latching connection to the first panels.

Alternatively or additionally, it is preferably provided that the housing of the kinematics module comprises corresponding snap-fitting or latching elements to create a snap-fitting or latching connection to the second panel of the air vent.

It is thus possible to adapt the optical design of the air vent to the specific purpose very easily and without much effort.

The invention further relates to a method for producing an air vent, in particular an air vent of the aforementioned type according to the invention.

### BRIEF DESCRIPTION OF THE DRAWINGS

Preferred embodiments of the present invention are described in more detail in the following with reference to the accompanying drawings.

The figures show:

FIG. 1 schematically and in an isometric view, an example embodiment of the housing of a kinematics module of the air vent according to the invention;

FIG. 2A schematically and in an isometric view, a first example embodiment of a kinematic assembly of the air vent according to the invention;

FIG. 2B schematically and in an isometric view, a second example embodiment of the kinematic assembly of the air vent according to the invention;

FIG. 3 schematically and in an isometric partial exploded view, an example embodiment of a kinematics module of the air vent according to the invention consisting of the housing according to FIG. 1 and the kinematic assembly according to FIG. 2A;

FIG. 4 schematically and in an isometric view, the kinematics module according to FIG. 3 in an assembled state;

FIG. 5 schematically and in an isometric partial exploded view, an example embodiment of a slat module of the air vent according to the invention;

FIG. 6 schematically and in an isometric view, the example embodiment of the slat module according to FIG. 5;

FIG. 7 schematically and in an isometric partial view, an example embodiment of the air vent according to the invention consisting of a slat module according to FIG. 6 and a kinematics module according to FIG. 4;

FIG. 8 schematically and in an isometric view, the example embodiment of the air vent according to the invention according to FIG. 7 in an assembled state;

FIG. 9 schematically and in an isometric partial exploded view, an embodiment of the air vent according to the invention consisting of the combination of the kinematics module and the slat module shown schematically in FIG. 8 as well as a panel arrangement;

FIG. 10 schematically and in an isometric view, the example embodiment of the air vent according to the invention according to FIG. 9 in an assembled state;

FIG. 11 schematically and in an isometric view, an example embodiment of an actuating element of the air vent according to the invention;

FIG. 12 schematically and in an isometric partial exploded view, a completion of a kinematics module from the kinematic assembly according to FIG. 2B, a kinematics housing, two additional air elements and coupling rods for linking the air-guiding elements;

FIG. 13 schematically and in an isometric view, the example embodiment of the kinematics module according to FIG. 12 in an assembled state;

FIG. 14 schematically and in an isometric partial exploded view, an example embodiment of the air vent according to the invention consisting of the kinematics module according to FIG. 13 and the slat module according to FIG. 5, whereby the kinematics module and the slat module form a base air vent;

FIG. 15 schematically and in an isometric view, the example embodiment of the air vent according to the invention according to FIG. 14 in an assembled state;

FIG. 16 schematically and in an isometric partial exploded view, a further embodiment of the air vent according to the invention consisting of the slat module according to FIG. 4, the kinematics module according to FIG. 13 and a panel arrangement; and

FIG. 17 schematically and in an isometric view, the example embodiment of the air vent according to the invention according to FIG. 16 in an assembled state.

### DETAILED DESCRIPTION

Various aspects of different embodiments of the air vent 1 according to the invention are described in more detail in the following with reference to the accompanying drawings.

Briefly summarized, all embodiments of the air vent 1 are characterized by their modular structure. For this purpose, the air vent 1 in particular comprises a kinematics module 7 and optionally an additional slat module 10 coupled to the kinematics module 7.

According to further embodiments of the air vent 1 according to the invention, said air vent is provided with a cover arrangement (panel arrangement 22, 23), which is preferably likewise implemented in a modular fashion.

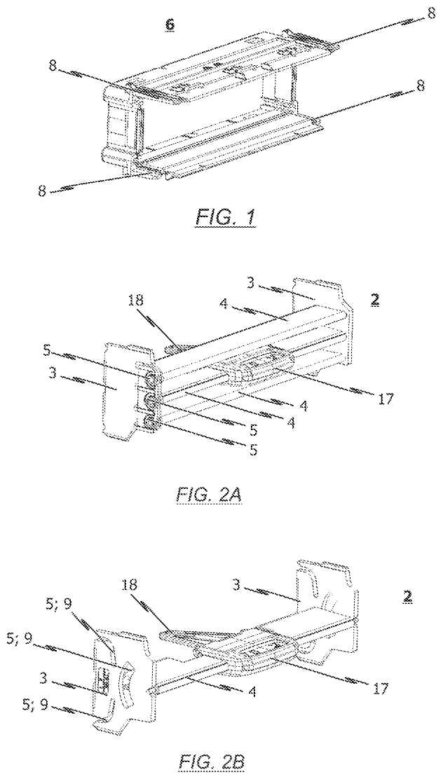

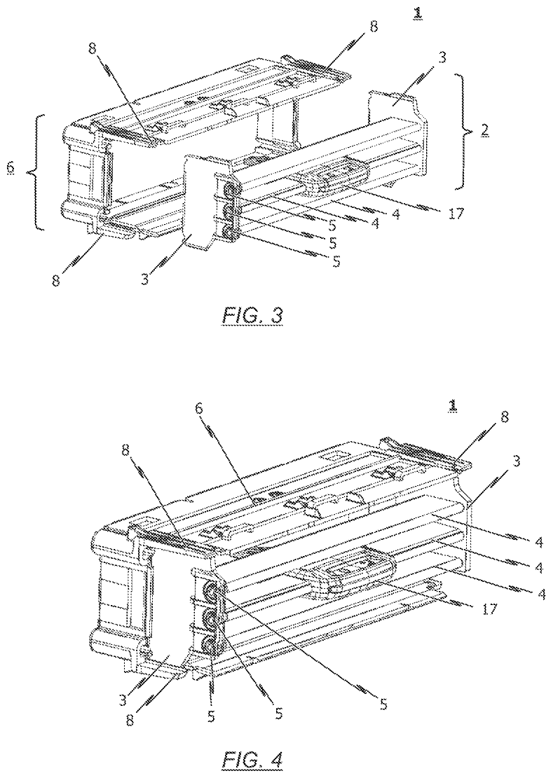

As shown in FIG. 1, for example, an example embodiment of the kinematics module 7 of the air vent 1 comprises a housing 6, which is designed to accommodate differently configured kinematic assemblies or to be connectable, in particular releasably connectable, to differently configured kinematic assemblies, in order to form a corresponding kinematics module 7.

Embodiments of the kinematic assemblies 2, which can be releasably connected to the housing 6 according to FIG. 1, are shown schematically and in a respective isometric view in FIG. 2A and FIG. 2B.

It can accordingly be seen that each kinematic assembly 2 comprises two side plates 3 and at least one air-guiding element 4, which can be moved and in particular pivoted between the two side plates 3 relative to the side plates 3. In the example embodiments of the kinematic assembly 2 shown in FIG. 2A and FIG. 2B, the air-guiding elements 4 (FIG. 2A) and/or the (only) air-guiding element 4 (FIG. 2B) are oriented in a horizontal plane and serve to deflect the air flow of the air vent 1 upward or downward.

An essential feature of the two example embodiments of the kinematic assembly 2 according to the invention shown schematically in FIG. 2A and FIG. 2B is that the kinematics 5 required for coordinating the movement of the at least one air-guiding element 4 are integrated into the respective side plates 3 of the kinematic assembly 2 or are provided on the side plates 3 of the kinematic assembly 2.

This measure allows the side plates 3 of each kinematic assembly 2 to be connectable to the modularly constructed housing 6 according to FIG. 1 independent of the kinematics 5 required for coordinating the movement of the at least one air-guiding element 4 belonging to the kinematic assembly 2, in order to thus form a corresponding kinematics module 7.

More specifically, it is provided in this context that the side plates 3 of each kinematic assembly 2 have a shape that is independent of the kinematics 5 required for coordinating the movement of the at least one air-guiding element 4 belonging to the kinematic assembly 2. The shape of the side plates 3 of the respective kinematic assembly 2 is furthermore at least regionally complementary to an adapter region of the housing 6 of the kinematics module 7 (see FIG. 1), so that, to form the kinematics module 7, the housing 6 can be connected, and, if applicable (but not absolutely necessarily), releasably connected, to differently configured kinematic assemblies 2.

As the comparison of the embodiments according to FIG. 2A and FIG. 2B shows, the housing 6 of the kinematics module 7 is configured to be connectable to different kinematic assemblies 2, whereby the different kinematic assemblies 2 differ in particular in a number of air-guiding elements 4 and/or in a kinematics 5 needed for coordinating the movement of the at least one air-guiding element 4 relative to the side plates 3.

As can be seen from the isometric view according to FIG. 1, an adapter region 8 of the housing of the kinematics module 7 is configured at least partly as a snap-fitting or latching mechanism in order to create a preferably releasable snap-fitting or latching connection to the side plates 3 of a corresponding kinematic assembly 2

The example embodiment of a kinematic assembly 2 of the air vent 1 according to the invention, shown schematically and in an isometric view in FIG. 2A, is characterized in that said kinematic assembly 2 comprises a plurality of air-guiding elements 4, which are respectively mounted between the two side plates 3 such that they are movable and in particular pivotable relative to the side plates 3.

A coupling mechanism is furthermore integrated into the side plates 3 or is at least configured in the immediate vicinity of the side plates 3 for coordinating the movements of the plurality of air-guiding elements 4 relative to one another and relative to the side plates 3.

In contrast to this, in the embodiment of the kinematic assembly 2 of the air vent 1 according to the invention shown schematically and in an isometric view in FIG. 2B, it is provided that at least one slotted guide 9 is configured in the side plates 3, into which a driver connected to the at least one air-guiding element 4 is accommodated for defining and/or guiding a movement of the at least one air-guiding element 4 relative to the sides 3.

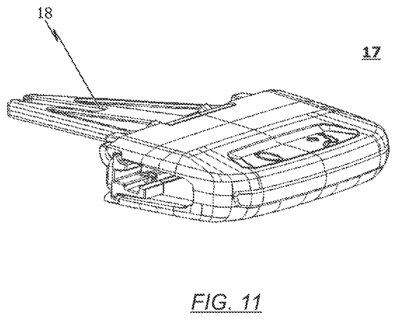

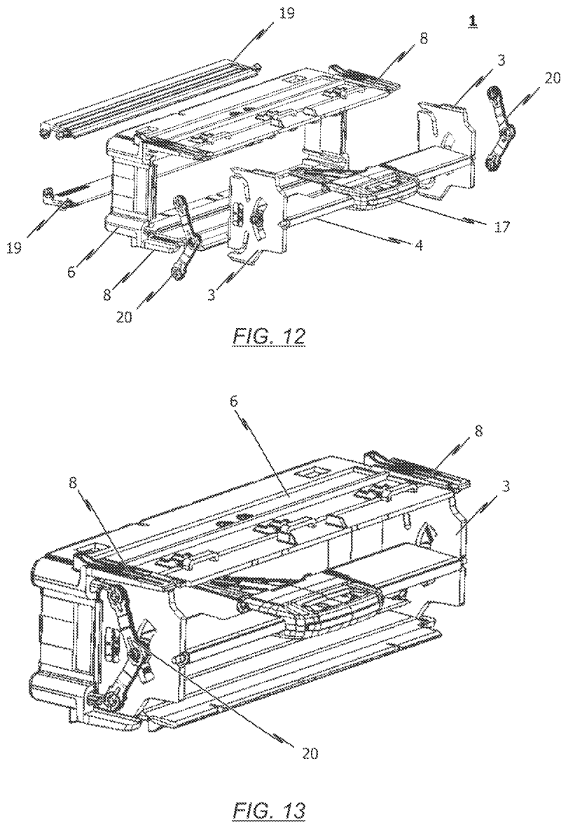

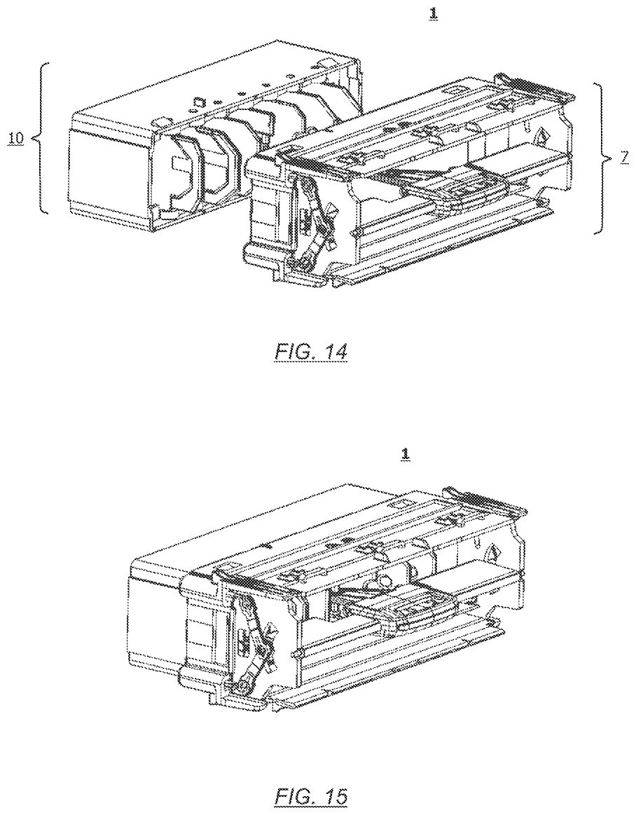

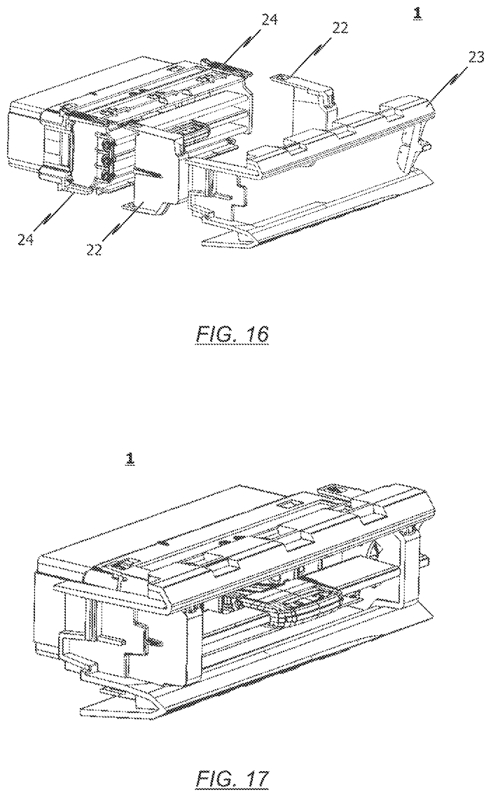

According to preferred further developments of the air vent 1 according to the invention, said air vent further comprises a preferably modularly constructed actuating element 17, as shown, for example, schematically and in an isometric view in FIG. 11.

The actuating element 17 is in particular used for manually manipulating the at least one air-guiding element 4 of the kinematic assembly 2. The modularly constructed actuating element 17 can preferably be connected to the at least one air-guiding element 4 in a releasable or interchangeable manner.

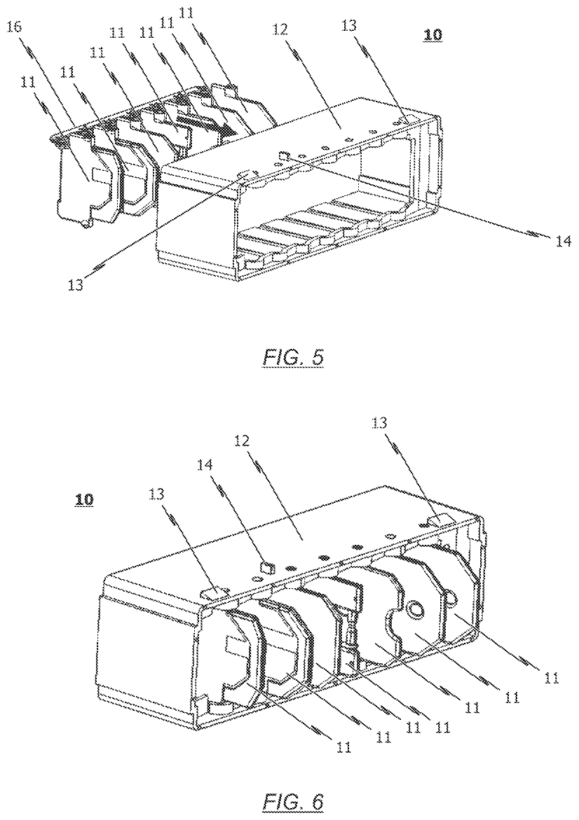

According to embodiments of the air vent 1 according to the invention, said air vent comprises a slat module 10, whereby an example embodiment of such a slat module 10 is shown schematically and in an isometric view in FIG. 5.

The slat module 10 can optionally or as needed be connected, and preferably releasably connected, to an air inlet region of the kinematics module 7 formed by the kinematic assembly 2 and the housing 6.

As can be seen from the isometric illustration according to FIG. 5, the slat module 10 preferably comprises at least one and particularly preferably a plurality of air-guiding slats 11 oriented perpendicular to the at least one air-guiding element 4 of the kinematic assembly 2 to shut off or laterally deflect, i.e. in horizontal direction, an air flow flowing through the air vent 1 as needed.

More specifically, in this context it is in particular provided that the slat module 10 comprises a housing 12, in which the air-guiding slats 11 are mounted such that they are movable and in particular pivotable relative to the housing 12. In this context, it is in particular provided that the housing 12 can preferably be releasably connected to the air-inlet region of the housing 6 of the kinematic assembly 2 via a snap-fitting or latching connection 13.

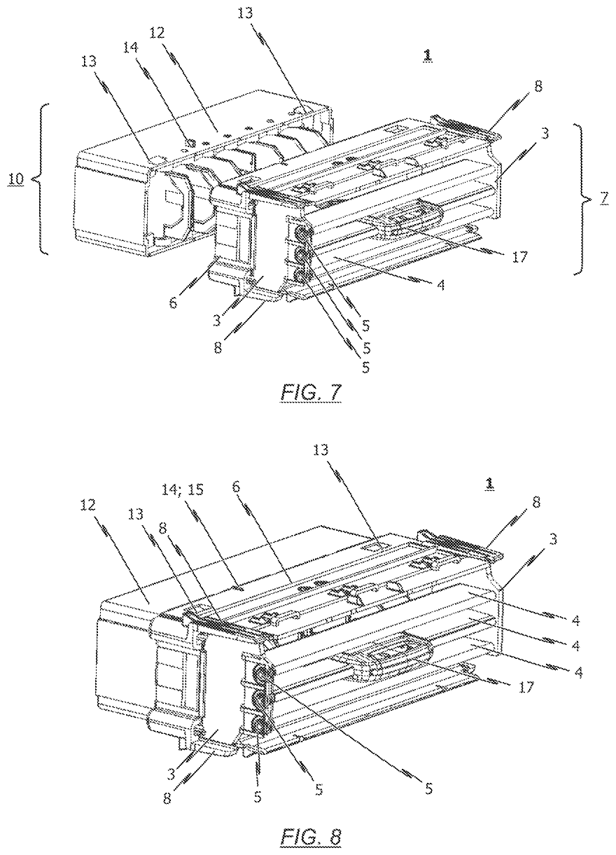

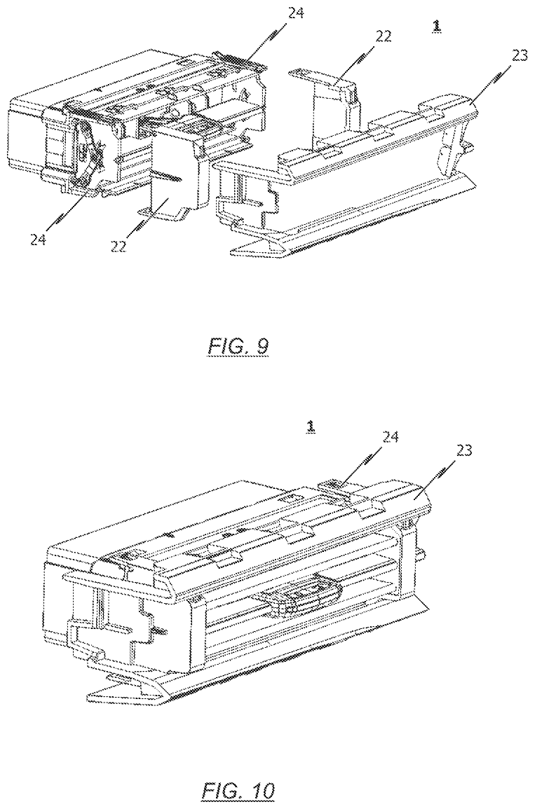

As can be seen from the illustrations in FIG. 6 or FIG. 7/FIG. 8, it is useful in this context for the housing 12 of the slat module 10 to preferably comprise a centering and/or guide element 14 and for the housing 6 of the kinematic assembly 2 to comprise a complementary element for centering and/or orienting the housing 12 of the slat module 10 relative to the housing 6 of the kinematic assembly 2.

As can be seen from the schematic and isometric partial exploded view in FIG. 5, the slat module 10 of the example embodiments of the air vent 1 according to the invention preferably comprises a corresponding coupling mechanism 16 to couple the individual air-guiding slats 11 of the slat module 10 to one another with respect to the movements to be carried out by said guiding slats.

If the air vent 1 according to the invention is equipped with a slat module 10, it is provided according to embodiments of the present invention that the actuating element 17, which is originally in particular provided for manually manipulating the at least one air-guiding element 4 of the kinematic assembly 2, comprises a force transmission element 18, the end region of which is operatively connected or operatively connectable to one of the at least one air-guiding slats 11 of the slat module 10.

Schematically and in an isometric partial exploded view, FIG. 12 shows a completion of a kinematics module 7 from the kinematic assembly 2 according to FIG. 2B, the kinematics housing 6, two additional air elements 19 and coupling rods 20 for linking the air-guiding elements 19.

The two additional air-guiding elements 19 are movable and in particular pivotable relative to the at least one air-guiding element 4 and relative to the housing 6 of the slat module 10.

In this context, it is in particular provided that the two additional air-guiding elements 19 extend parallel to the at least one air-guiding element 4 of the kinematic assembly 2.

In this context, it is in particular useful for the two additional air-guiding elements 19 to be associated with a coupling mechanism 20, whereby the coupling mechanism 20 is configured to orient the two additional air-guiding elements 19 in the opposite direction to the at least one air-guiding element 4 of the kinematic assembly 2.

As can be seen from the exploded view in FIG. 12, for example, it is conceivable that the coupling mechanism 20 comprises at least one lever arm, which is connected in an articulated manner to an end face of the additional air-guiding element 19 on one side and in an articulated manner to an end face of the at least one air-guiding element 4 of the kinematic assembly 2 on the other side.

According to preferred further developments of the air vent 1 according to the invention, it is provided that the air vent 1 further comprises a preferably modularly implemented panel arrangement 22, 23, which is preferably releasably or interchangeably connectable to the kinematics module 7.

According to further developments of the air vent 1 according to the invention, it is in particular provided that the panel arrangement comprises first panels 22 for covering the side plates 3 of the kinematic assembly 2 as needed and a second 23 panel for covering the housing 6 of the kinematics module 7 on the air-outlet region of the air vent 1 as needed.

In this context, it is in particular conceivable that the side plates 3 comprise snap-fitting or latching elements 24 for creating a snap-fitting or latching connection with the first panels 22.

Alternatively or additionally, it is advantageous for the housing 6 of the kinematics module 7 to comprise corresponding snap-fitting or latching elements 25 for creating a snap-fitting or latching connection to the second panel 23 of the panel arrangement.

The invention is not limited to the embodiments of the air vent 1 according to the invention shown in the drawings, but results when all of the features disclosed herein are considered together.

This also applies in particular to the potential combination of components. It is thus conceivable that the housing 12 of the slat module 10 and the housing 6 of the kinematics module 7 can be integrally connected to one another. In this case, the modularity relates in particular to the interchangeability of the kinematics assemblies according to FIG. 2A and FIG. 2B and, in this context, in particular to the use of side plates 3.

With respect to the illustration in FIG. 5, it should also be noted that an interchangeability of the slat packet, consisting of the slats 11 and the coupling mechanism 16, is generally conceivable as well. This makes it possible to install slat packets with or without a closing function in the same housing 12. It is furthermore also conceivable to include suitable plates in the housing 12 for the mounting of the rear slats 11.

The invention in particular also relates to a method for producing/installing a corresponding air vent 1.

### LIST OF REFERENCE SIGNS

1 Air vent
2 Kinematic assembly
3 Side plates
4 Air-guiding element
5 Kinematics
6 Housing of the kinematics module
7 Kinematics module
8 Adapter region of the housing of the kinematics module
9 Slotted guide
10 Slat module
11 Air-guiding element of the slat module
12 Housing of the slat module
13 Snap-fitting or latching connection of the slat module
14 Centering and/or guide element of the slat module
15 Centering and/or guide element of the housing of the kinematic assembly
16 Coupling mechanism of the slat module
17 Actuating element
18 Force transmission element of the actuating element
19 Air-guiding element of the kinematics module
20 Coupling mechanism of the air-guiding element of the slat module
21 Snap-fitting or latching mechanism of the adapter region of the housing of the kinematics module
22 First panel of the panel arrangement
23 Second panel of the panel arrangement
24 Snap-fitting or latching elements of the side plates
25 Snap-fitting or latching elements of the housing of the kinematics module

What is claimed is:

1. Air vent (1) for vehicles, comprising a housing (6) and a kinematic assembly (2) which can be accommodated at least partly by the housing (6) and comprises two side plates (3) and at least one air-guiding element (4) which is movable between the two side plates (3) relative to the side plates (3), wherein the kinematics (5) required for coordinating the movement of the at least one air-guiding element (4) are integrated into the side plates (3) or provided on the side plates (3), and wherein the side plates (3) have a shape that is independent of the kinematics (5) required for coordinating the movement of the at least one air-guiding element (4) and is at least regionally complementary to an adapter region (8) of the housing (6), such that, in order to form a kinematics module (7), the housing (6) is releasably connectable to differently configured kinematic assemblies (2).

2. Air vent (1) according to claim 1,
wherein the housing (6) is connectable to kinematic assemblies (2) that differ in the number of air-guiding elements (4) and/or in the kinematics (5) needed for coordinating the movement of the at least one air-guiding element (4) relative to the side plates (3).

3. Air vent (1) according to claim 1,
wherein the adapter region (8) of the housing (6) is at least partly configured as a snap-fitting or latching mechanism (21) in order to create a releasable snap-fitting or latching connection to the side plates (3) of the kinematic assembly (2); and/or
wherein the adapter region (8) of the housing (6) is at least partly configured to accommodate the side plates (3) of the kinematic assembly (2) at least regionally in a form-fitting manner.

4. Air vent (1) according to claim 1,
wherein the kinematic assembly (2) comprises a plurality of air-guiding elements (4), which are respectively mounted between the two side plates (3) such that they are movable relative to the side plates (3), wherein a coupling mechanism is integrated into the side plates (3) or disposed on the side plates (3) for coordinating the movements of the plurality of air-guiding elements (4) relative to one another and relative to the side plates (3).

5. Air vent (1) according to claim 1,
wherein at least one slotted guide (9) is configured in the side plates (3), in which a driver connected to the at least one air-guiding element (4) is accommodated to define and/or guide a movement of the at least one air-guiding element (4) relative to the side plates (3).

6. Air vent (1) according to claim 1,
wherein the air vent (1) further comprises an actuating element (17) for manipulating the at least one air-guiding element (4) of the kinematic assembly (2), wherein the actuating element (17) is releasably or interchangeably, connectable to the at least one air-guiding element (4).

7. Air vent (1) according to claim 1,
wherein the air vent (1) further comprises a slat module (10), which can be connected, selectively or as needed, to an air-inlet region of the kinematics module (7) formed by the kinematic assembly (2) and the housing (6), wherein the slat module (10) comprises a plurality of air-guiding slats or air-guiding elements (11) oriented perpendicular to the at least one air-guiding element (4) of the kinematic assembly (2) to shut off or laterally deflect an air flow flowing through the air vent (1) as needed.

8. Air vent (1) according to claim 1,
wherein the slat module (10) comprises a housing (12), in which the plurality of air-guiding slats or air-guiding elements (11) are mounted such that they are movable relative to the housing (12), and wherein the housing (12) is releasably connectable via a snap-fitting or latching connection (13), to the air-inlet region of the housing (6) of the kinematic assembly (2), wherein the housing (6) of the slat module (10) comprises a centering and/or guide element (14) and the housing (6) of the kinematic assembly (2) comprises a complementary element for centering and/or orienting the housing (6) of the closing-slat module (10) relative to the housing (6) of the kinematic assembly (2).

9. Air vent (1) according to claim 8,
wherein the housing (12) of the slat module (10) is integrally connected to the housing (6) of the air vent (1).

10. Air vent according to claim 8,
wherein the housing (12) of the slat module (10) comprises two side plates, wherein the plurality of air-guiding slats or air-guiding elements (11) are accommodated or mounted between the two side plates such that the plurality of air-guiding slats (11) are movable relative to the side plates.

11. Air vent (1) according to claim 7,
wherein the closing-slat module (10) comprises a plurality of air-guiding slats or air-guiding elements (11) that can be moved relative to the housing (6) of the closing-slat module (10) and a coupling mechanism (16) for coupling the movement of the individual air-guiding slats or air-guiding elements (11).

12. Air vent (1) according to claim 7,
wherein the kinematic assembly (2) comprises at least two additional peripheral air-guiding elements (19), which can be moved relative to the at least one air-guiding element (4) of the kinematic assembly (2) and relative to the housing (6) of the air vent (1), and which extend(s) parallel to the at least one air-guiding element (4) of the kinematic assembly (2).

13. Air vent (1) according to claim 12,
wherein the at least one additional air-guiding element (19) of the kinematic assembly (2) is associated with a coupling mechanism (20), wherein the coupling mechanism (20) is configured to orient the at least one additional air-guiding element (19) of the kinematic assembly (2) with respect to the at least one air-guiding element (4) of the kinematic assembly (2) in the opposite direction to the at least one air-guiding element (4) of the kinematic assembly (2).

14. Air vent (1) according to claim 13,
wherein the coupling mechanism (20) comprises at least one lever arm, which is connected in an articulated manner to an end face of the at least one additional air-guiding element (19) of the kinematic assembly (2) on one side and in an articulated manner to an end face of the at least one air-guiding element (4) of the kinematic assembly (2) on the other side.

15. Air vent (1) according claim 7,
wherein the actuating element (17) comprises a force transmission element (18), the end region of which is operatively connected or operatively connectable to one of the at least one air-guiding slats (11) or to an air-guiding element (11) of the closing-slat module (10).

16. Air vent (1) according to claim 1,
wherein the air vent (1) further comprises a panel arrangement (22, 23), which can be connected to the kinematics module (5) in a releasable or interchangeable manner.

17. Air vent (1) according to claim 16,
wherein the panel arrangement (22, 23) comprises first panels (22) for covering the side plates (3) as needed and a second panel (23) for covering the housing (6) of the kinematics module (7) on the air-outlet region of the air vent (1) as needed, wherein the side plates (3) comprise snap-fitting or latching elements (24) for creating a snap-fitting or latching connection to the first panels (22) and/or wherein the housing (6) of the kinematics module (7) comprises snap-fitting or latching elements (25) for creating a snap-fitting or latching connection to the second panel (23).
